(19) United States
(12) Patent Application Publication
(10) Pub. No.: US 2010/0061809 A1
(43) Pub. Date: Mar. 11, 2010

(54) SYSTEMS AND METHODS FOR REDUCING DRAG AND/OR VORTEX INDUCED VIBRATION

(75) Inventors: Donald Wayne Allen, Richmond, TX (US); Dean Leroy Henning, Needville, TX (US); Li Lee, Houston, TX (US); David Wayne McMillan, Deer Park, TX (US); Janet Kay McMillan, Deer Park, TX (US)

Correspondence Address: SHELL OIL COMPANY, P O BOX 2463, HOUSTON, TX, 772522463, US

(73) Assignee: Shell Oil Company, Houston, TX (US)

(21) Appl. No.: 12/515,922

(22) PCT Filed: Nov. 16, 2007
(86) PCT No.: PCT/US07/84918

§ 371 Date: Jul. 20, 2009

Related U.S. Application Data
(60) Provisional application No. 60/866,972, filed on Nov. 22, 2006.

(51) Int. Cl. F15D 1/10; E02D 31/00; E02D 5/60

(52) U.S. Cl. 405/216

(57) ABSTRACT

There is disclosed a system for reducing drag and/or vortex induced vibration of a structure, the system comprising a fairing comprising a dampening mechanism adapted to dampen the rotation of the fairing about the structure.

### FIELD OF THE INVENTION

The present invention relates to systems and methods for reducing drag and/or vortex-induced vibration (“VIV”) with the use of a fairing.

### DESCRIPTION OF THE RELATED ART

Whenever a bluff body, such as a cylinder, experiences a current in a flowing fluid environment, it is possible for the body to experience vortex-induced vibration (VIV). These vibrations may be caused by oscillating dynamic forces on the surface, which can cause substantial vibrations of the structure, especially if the forcing frequency is at or near a structural natural frequency.

Drilling for and/or producing hydrocarbons or the like from subterranean deposits which exist under a body of water exposes underwater drilling and production equipment to water currents and the possibility of VIV. Equipment exposed to VIV includes structures ranging from the smaller tubes of a riser system, anchoring tendons, or lateral pipelines to the larger underwater cylinders of the hull of a mini spar or spar floating production system (hereinafter “spar”).

The magnitude of the stresses on the riser pipe, tendons or spars may be generally a function of and increases with the velocity of the water current passing these structures and the length of the structure.

It is noted that even moderate velocity currents in flowing fluid environments acting on linear structures can cause stresses. Such moderate or higher currents may be readily encountered when drilling for offshore oil and gas at greater depths in the ocean or in an ocean inlet or near a river mouth.

Drilling in ever deeper water depths requires longer riser pipe strings which, because of their increased length and subsequent greater surface area, may be subject to greater drag forces which must be resisted by more tension. This is believed to occur as the resistance to lateral forces due to the bending stresses in the riser decreases as the depth of the body of water increases.

Accordingly, the adverse effects of drag forces against a riser or other structure caused by strong and shifting currents in these deeper waters increase and set up stresses in the structure which can lead to severe fatigue and/or failure of the structure if left unchecked.

There are generally two kinds of current-induced stresses in flowing fluid environments. The first kind of stress may be caused by vortex-induced alternating forces that vibrate the structure (“vortex-induced vibrations”) in a direction perpendicular to the direction of the current. When fluid flows past the structure, vortices may be alternately shed from each side of the structure. This produces a fluctuating force on the structure transverse to the current. If the frequency of this harmonic load is near the resonant frequency of the structure, large vibrations transverse to the current can occur. These vibrations can, depending on the stiffness and the strength of the structure and any welds, lead to unacceptably short fatigue lives. In fact, stresses caused by high current conditions in marine environments have been known to cause structures such as risers to break apart and fall to the ocean floor.

The second type of stress may be caused by drag forces, which push the structure in the direction of the current due to the structure's resistance to fluid flow. The drag forces may be amplified by vortex-induced vibration of the structure. For instance, a riser pipe that is vibrating due to vortex shedding will generally disrupt the flow of water around it more than a stationary riser. This may result in more energy transfer from the current to the riser, and hence more drag.

Many types of devices have been developed to reduce vibrations and/or drag of sub sea structures. Some of these devices used to reduce vibrations caused by vortex shedding from sub sea structures operate by stabilization of the wake. These methods include use of streamlined fairings, wake splitters and flags.

Devices used to reduce vibrations caused by vortex shedding from sub-sea structures may operate by modifying the boundary layer of the flow around the structure to prevent the correlation of vortex shedding along the length of the structure. Examples of such devices include sleeve-like devices such as helical strakes, shrouds, fairings and substantially cylindrical sleeves.

Elongated structures in wind or other flowing fluids can also encounter VIV and/or drag, comparable to that encountered in aquatic environments. Likewise, elongated structures with excessive VIV and/or drag forces that extend far above the ground can be difficult, expensive and dangerous to reach by human workers to install VIV and/or drag reduction devices.

Fairings may be used to suppress VIV and reduce drag acting on a structure in a flowing fluid environment. Fairings may be defined by a chord to length ratio, where longer fairings have a higher ratio than shorter fairings. Long fairings are more effective than short fairings at resisting drag, but may be subject to instabilities. Short fairings are less subject to instabilities, but may have higher drag in a flowing fluid environment.

U.S. Pat. No. 6,223,672 discloses an ultrashort fairing for suppressing vortex-induced vibration in substantially cylindrical marine elements. The ultrashort falling has a leading edge substantially defined by the circular profile of the marine element for a distance following at least about 270 degrees thereabout and a pair of shaped sides departing from the circular profile of the marine riser and converging at a trailing edge. The ultrashort fairing has dimensions of thickness and chord length such that the chord to thickness ratio is between about 1.20 and 1.10. U.S. Pat. No. 6,223,672 is herein incorporated by reference in its entirety.

U.S. Pat. No. 4,398,487 discloses a fairing for elongated elements for reducing current-induced stresses on the elongated element. The fairing is made as a stream-lined shaped body that has a nose portion in which the elongated element is accommodated and a tail portion. The body has a bearing connected to it to provide bearing engagement with the elongated element. A biasing device interconnected with the bearing accommodates variations in the outer surface of the elongated element to maintain the fairing's longitudinal axis substantially parallel to the longitudinal axis of the elongated element as the fairing rotates around the elongated element. The fairing is particularly adapted for mounting on a marine drilling riser having flotation modules. U.S. Pat. No. 4,398,487 is herein incorporated by reference in its entirety.

Referring now to FIG. 1, there is illustrated prior art short fairing 104 installed about structure 102. Structure 102 may be subjected to a flowing fluid environment, where short fairing 104 may be used to suppress vortex induced vibration (VIV). Short fairing 104 has chord 106 and thickness 108. Chord to thickness ratio of short fairing 104 may be less than about 1.5, or less than about 1.25. While short fairing 104 is effective at reducing vortex induced vibration, short fairing 104 may be subject to drag forces 110 in a flowing fluid environment.

Referring now to FIG. 2, prior art long fairing 204 is illustrated installed about structure 202. Structure 202 may be in a flowing fluid environment where structure 202 is subject to vortex induced vibration. Compared to short fairing 104, long fairing 204 may have reduced drag when subjected to a flowing fluid environment. Long fairing 204 has chord 206 and thickness 208. Chord to thickness ratio of long fairing 204 may be greater than about 1.7, greater than about 1.8, or greater than about 2.0. Although long fairing 204 may have lower drag than short fairing 104, long fairing 204 may be subject to flutter, galloping, and/or a plunge-torsional instability. Long fairing 204 may experience lateral displacement 210 and/or torsional displacement 212.

There are needs in the art for one or more of the following: apparatus and methods for reducing VIV and/or drag on structures in flowing fluid environments, which do not suffer from certain disadvantages of the prior art apparatus and methods; low drag fairings; high stability fairings; fairings which delay the separation of the boundary layer, which cause decreased drag, and/or decreased VIV; fairings suitable for use at a variety of fluid flow velocities; and/or fairings that have a low drag and high stability.

These and other needs in the art will become apparent to those of skill in the art upon review of this specification, including its drawings and claims.

### SUMMARY OF THE INVENTION

One aspect of invention provides a system for reducing drag and/or vortex induced vibration of a structure, the system comprising a fairing comprising a dampening mechanism adapted to dampen the rotation of the fairing about the structure.

Another aspect of invention provides a method for modifying a structure subject to drag and/or vortex induced vibration, said method comprising positioning at least one fairing around the structure; and dampening the rotation of the fairing about the structure.

Advantages of the invention may include one or more of the following: improved VIV reduction; improved drag reduction; improved fairing stability; delaying the separation of the boundary layer over the fairing body; lower cost fairings; and/or lighter weight fairings.

These and other aspects of the invention will become apparent to those of skill in the art upon review of this specification, including its drawings and claims.

### BRIEF DESCRIPTION OF THE DRAWINGS

FIG. 1 shows a prior art short fairing.

FIG. 2 shows a prior art long fairing.

FIGS. 3a-3f show improved long fairings.

FIG. 4 shows a plurality of long fairings installed about a structure.

FIG. 5 shows a plurality of long and short fairings installed about a structure.

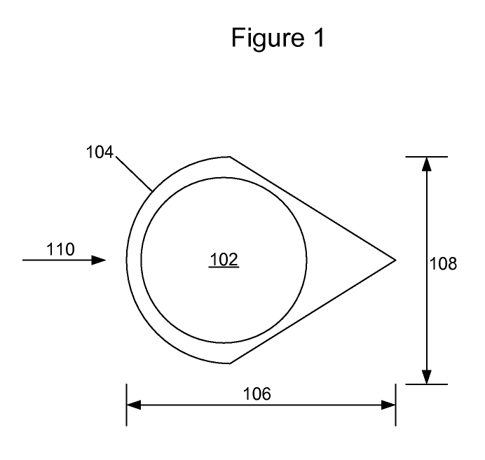

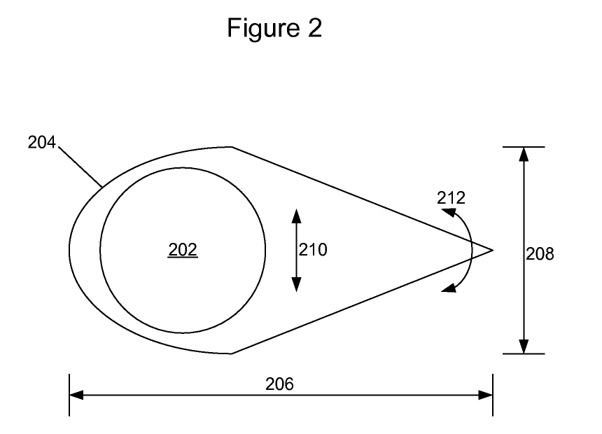

### DETAILED DESCRIPTION OF THE INVENTION

In one embodiment, there is disclosed a system for reducing drag and/or vortex induced vibration of a structure, the system comprising a fairing comprising a dampening mechanism adapted to dampen the rotation of the fairing about the structure. In some embodiments, the dampening mechanism comprises at least one mechanism selected from the group consisting of perforations in a tail section of the fairing, a mass in a nose section of the fairing, a buoyancy module in the tail section of the fairing, perforations and balls and/or rods in the tail section of the fairing, a liquid container in the tail section of the fairing, a liquid container in the nose section of the fairing, friction pads between the fairing and the structure, and pins attached to the fairing within tracks moveably connected to the structure. In some embodiments, the fairing comprises a chord to thickness ratio of greater than 1.5. In some embodiments, the fairing comprises a chord to thickness ratio of greater than 1.75. In some embodiments, the fairing comprises a chord to thickness ratio of greater than 2. In some embodiments, the fairing comprises a chord to thickness ratio of greater than 2.25. In some embodiments, the fairing comprises a chord to thickness ratio up to about 4. In some embodiments, the fairing comprises a chord to thickness ratio up to about 3. In some embodiments, the fairing comprises a chord to thickness ratio up to about 2.75. In some embodiments, the fairing comprises a tail section comprising one or more stabilizer fins and/or drag plates. In some embodiments, the fairing comprises a teardrop shape.

In another embodiment, there is disclosed a method for modifying a structure subject to drag and/or vortex induced vibration, said method comprising positioning at least one fairing around the structure; and dampening the rotation of the fairing about the structure. In some embodiments, the positioning comprises positioning at least two fairings about the structure. In some embodiments, the method also includes positioning a collar, a buoyancy module, and/or a clamp around the structure. In some embodiments, the fairing comprises a teardrop shape. In some embodiments, the method also includes connecting at least two fairings to each other. In some embodiments, the method also includes positioning a plurality of long fairings about the structure and a plurality of short fairings about the structure, and alternating at least 1 short fairing between every at least one long fairing. In some embodiments, the short fairing comprises a chord to thickness ratio of less than 1.5, and the long fairing comprises a chord to thickness ratio of greater than 1.75. In some embodiments, the method also includes dampening a lateral motion of the fairing and/or the structure.

The VIV systems and methods disclosed herein may be used in any flowing fluid environment in which the structural integrity of the system can be maintained. The term, “flowing-fluid” is defined here to include but not be limited to any fluid, gas, or any combination of fluids, gases, or mixture of one or more fluids with one or more gases, specific non-limiting examples of which include fresh water, salt water, air, liquid hydrocarbons, a solution, or any combination of one or more of the foregoing. The flowing-fluid may be “aquatic,” meaning the flowing-fluid comprises water, and may comprise seawater or fresh water, or may comprise a mixture of fresh water and seawater.

In some embodiments, fairings of the invention may be used with most any type of offshore structure, for example, bottom supported and vertically moored structures, such as for example, fixed platforms, compliant towers, tension leg platforms, and mini-tension leg platforms, and also include floating production and subsea systems, such as for example, spar platforms, floating production systems, floating production storage and offloading, and subsea systems.

In some embodiments, fairings may be attached to marine structures such as subsea pipelines; drilling, production, import and export risers; tendons for tension leg platforms; legs for traditional fixed and for compliant platforms; space-frame members for platforms; cables; umbilicals; mooring elements for deepwater platforms; and the hull and/or column structure for tension leg platforms (TLPs) and for spar type structures. In some embodiments, fairing may be attached to spars, risers, tethers, and/or mooring lines.

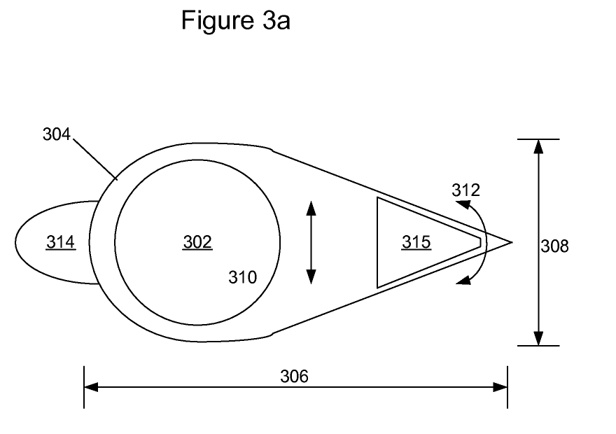

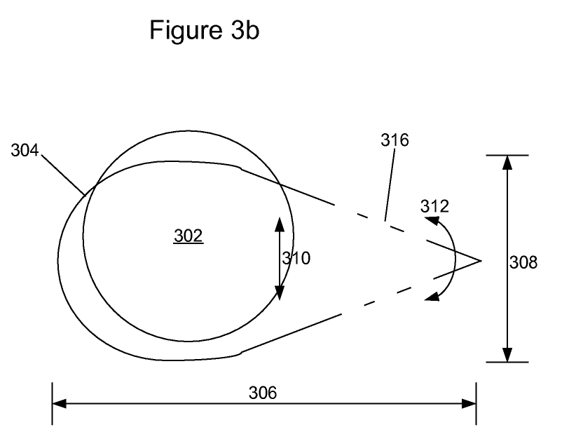

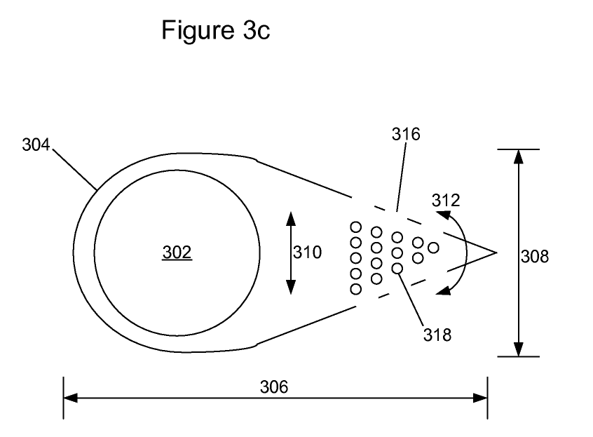

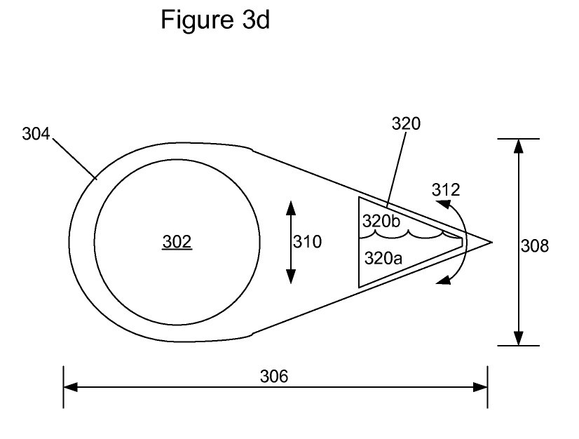

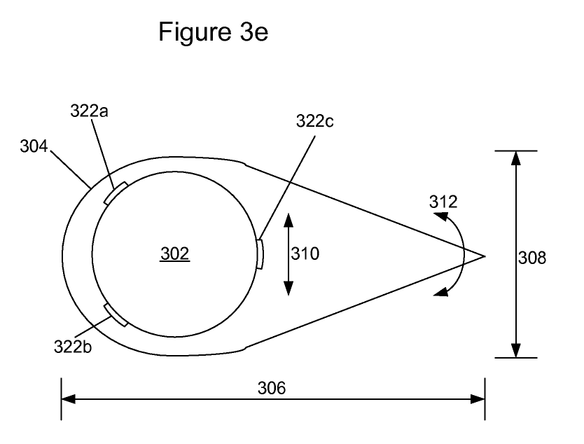

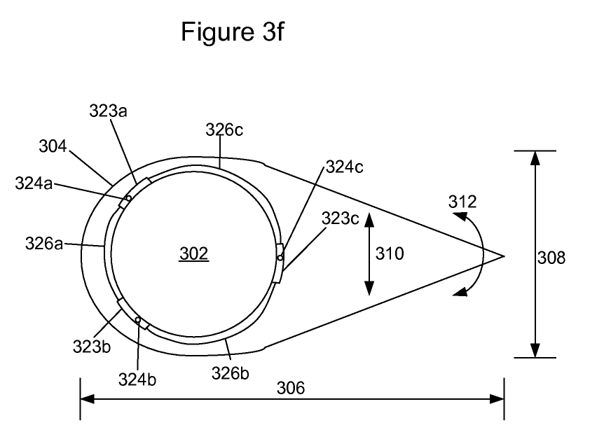

Referring now to FIG. 3a, in some embodiments, long fairing 304 is illustrated. Long fairing 304 is shown installed about structure 302. Structure 302 may be in a flowing fluid environment where structure 302 is subject to vortex induced vibration. Long fairing 304 may be used to suppress the vortex induced vibration of structure 302.

Long fairing 304 may experience lateral displacement 310 and/or torsional displacement 312. Fairing 304 has chord 306 and thickness 308. Chord to thickness ratio of long fairing 304 in a high level fluid flow environment may be greater than about 1.75, greater than about 2.0, or greater than about 2.25, and up to about 4, up to about 3, or up to about 2.75.

Fairing 304 may include streamlined mass 314 at nose section and/or buoyancy 315 in tail section. Mass 314 and/or buoyancy 315 act to shift fairing's 304 center of mass forward towards the nose section. Shifting fairing's 304 center of mass forward may act to shorten fairing's 304 instability moment, which is defined as the distance between the center of mass and the center of rotation.

In some embodiments, in a high level fluid flow environment, a long fairing is desired since the drag force on fairing 304 will be high, and the long fairing needs good stability.

Referring now to FIG. 3b, in some embodiments, long fairing 304 is illustrated. Long fairing 304 is shown installed about structure 302. Structure 302 may be in a flowing fluid environment where structure 302 is subject to vortex induced vibration. Long fairing 304 may be used to suppress the vortex induced vibration of structure 302.

Long fairing 304 may experience lateral displacement 310 and/or torsional displacement 312. Fairing 304 has chord 306 and thickness 308. Chord to thickness ratio of long fairing 304 in a high level fluid flow environment may be greater than about 1.75, greater than about 2.0, or greater than about 2.25, and up to about 4, up to about 3, or up to about 2.75.

Fairing 304 may include perforations 316 in tail section. Perforations 316 may act to dampen fairing's 304 lateral displacement 310 and/or torsional displacement 312. When fairing 304 moves laterally and/or rotationally, fluid flows into and/or out of perforations 316 in and/or out of the tail section. This fluid flow may act to dampen the fairing's 304 movements.

Referring now to FIG. 3c, in some embodiments, long fairing 304 is illustrated. Long fairing 304 is shown installed about structure 302. Structure 302 may be in a flowing fluid environment where structure 302 is subject to vortex induced vibration. Long fairing 304 may be used to suppress the vortex induced vibration of structure 302.

Long fairing 304 may experience lateral displacement 310 and/or torsional displacement 312. Fairing 304 has chord 306 and thickness 308. Chord to thickness ratio of long fairing 304 in a high level fluid flow environment may be greater than about 1.75, greater than about 2.0, or greater than about 2.25, and up to about 4, up to about 3, or up to about 2.75.

Fairing 304 may include perforations 316 and balls and/or rods 318 in tail section. Perforations 316 and balls and/or rods 318 may act to dampen fairing's 304 lateral displacement 310 and/or torsional displacement 312. When fairing 304 moves laterally and/or rotationally, fluid flows into and/or out of perforations 316 in and/or out of the tail section, the fluid flow traveling across the tail section from one set of perforations 316 to the other will encounter balls and/or rods 318, and have to flow around them. This hindered fluid flow through the perforations 316 may act to dampen the fairing's 304 movements.

Referring now to FIG. 3d, in some embodiments, long fairing 304 is illustrated. Long fairing 304 is shown installed about structure 302. Structure 302 may be in a flowing fluid environment where structure 302 is subject to vortex induced vibration. Long fairing 304 may be used to suppress the vortex induced vibration of structure 302.

Long fairing 304 may experience lateral displacement 310 and/or torsional displacement 312. Fairing 304 has chord 306 and thickness 308. Chord to thickness ratio of long fairing 304 in a high level fluid flow environment may be greater than about 1.75, greater than about 2.0, or greater than about 2.25, and up to about 4, up to about 3, or up to about 2.75.

Fairing 304 may include partially filled container 320 in tail section. Container 320 has high density fluid 320a and low density fluid 320b, for example air and water. Container 320 may act to dampen fairing's 304 lateral displacement 310 and/or torsional displacement 312. When fairing 304 moves laterally and/or rotationally, high density fluid 320a and low density fluid 320b will interact within container 320 absorbing energy by sloshing in container 320. This sloshing in container 320 may act to dampen the fairing's 304 movements.

In some embodiments, container 320 may provide buoyancy to tail section when fairing 304 is placed in a fluid environment, for example water. In some embodiments, container 320 may be attached to the nose section of fairing 304, and/or may provide additional mass to the nose section.

Referring now to FIG. 3e, in some embodiments, long fairing 304 is illustrated. Long fairing 304 is shown installed about structure 302. Structure 302 may be in a flowing fluid environment where structure 302 is subject to vortex induced vibration. Long fairing 304 may be used to suppress the vortex induced vibration of structure 302.

Long fairing 304 may experience lateral displacement 310 and/or torsional displacement 312. Fairing 304 has chord 306 and thickness 308. Chord to thickness ratio of long fairing 304 in a high level fluid flow environment may be greater than about 1.75, greater than about 2.0, or greater than about 2.25, and up to about 4, up to about 3, or up to about 2.75.

Fairing 304 may include friction pads 322a, 322b, and 322c in nose section attached between fairing 304 and structure 302. Pads 322a, 322b, and 322c may act to dampen fairing's 304 torsional displacement 312. When fairing 304 moves rotationally, pads 322a, 322b, and 322c will resist motion between fairing 304 and structure 302. This friction may act to dampen fairing's 304 movements. In some embodiments, pads 322a, 322b, and 322c may comprise a polymer, for example rubber, polybutylene, polyethylene, and/or polypropylene. In some embodiments, pads 322a, 322b, and 322c may be subject to a biasing force into engagement with structure 302. This biasing force may be provided by one or more springs, and/or a tensioned strap about pads 322a, 322b, and 322c and structure 302.

Referring now to FIG. 3f, in some embodiments, long fairing 304 is illustrated. Long fairing 304 is shown installed about structure 302. Structure 302 may be in a flowing fluid environment where structure 302 is subject to vortex induced vibration. Long fairing 304 may be used to suppress the vortex induced vibration of structure 302.

Long fairing 304 may experience lateral displacement 310 and/or torsional displacement 312. Fairing 304 has chord 306 and thickness 308. Chord to thickness ratio of long fairing 304 in a high level fluid flow environment may be greater than about 1.75, greater than about 2.0, or greater than about 2.25, and up to about 4, up to about 3, or up to about 2.75.

Fairing 304 may include pins 324a, 324b, and 324c in nose section attached to fairing 304. Pins 324a, 324b, and 324c fit within tracks 323a, 323b, and 323c. Tracks 323a, 323b, and 323c limit the short term movement of pins 324a, 324b, and 324c and fairing to a small angular displacement, for example from about 5 to about 30 degrees, or from about 10 to about 20 degrees. Tracks 323a, 323b, and 323c are attached to each other by connectors 326a, 326b, and 326c. Tracks 323a, 323b, and 323c are moveably connected to structure 302 with a dampening mechanism, for example a friction pad and/or a tension in connectors 326a, 326b, and 326c that forces tracks 323a, 323b, and 323c into engagement with structure 302.

In some embodiments, when the direction of fluid flow changes in the short term, for example less than about 5 or less than about 10 seconds, the motion of fairing 304 is limited to the motion of pins 324a, 324b, and 324c within tracks 323a, 323b, and 323c. In some embodiments, when the direction of fluid flow changes in the long term, for example greater than about 15 or greater than about 30 seconds, the motion of fairing 304 forces pins 324a, 324b, and 324c into engagement with the ends of tracks 323a, 323b, and 323c, which forces tracks 323a, 323b, and 323c and connectors 326a, 326b, and 326c to move about structure 302, until fairing 304 aligns with when the direction of fluid flow.

In some embodiments, a plurality of the mechanisms discussed above in FIGS. 3a, 3b, 3c, 3d, 3e, and 3f may be combined to improve the stability of fairing 304. For example, perforations 316 may be combined with mass 314 and/or buoyancy 315.

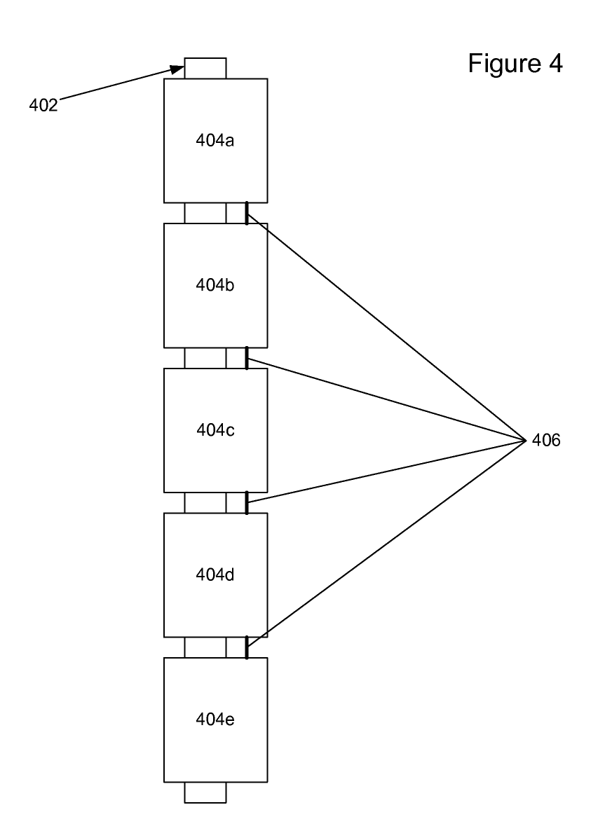

Referring now to FIG. 4, structure 402 is illustrated with a plurality of long fairings 404a, 404b, 404c, 404d, and 404e installed about structure 402 in order to suppress vortex induced vibration of structure 402, when structure 402 is subjected to a fluid flow. In some embodiments, connectors 406 may be provided between adjacent fairings or placed between every few fairings. In some embodiments, connectors 406 may be springs, bungee cords, rubber straps, ropes, rods, cables, or combinations of two or more of the above.

In some embodiments, collars may be provided between adjacent fairings or placed between every few fairings. In some embodiments, fairings 404a-404e may be installed before structure is installed, for example in a subsea environment. In some embodiments, fairings 404a-404e may be installed as a retrofit installation to structure 402 which has already been installed, for example in a subsea environment.

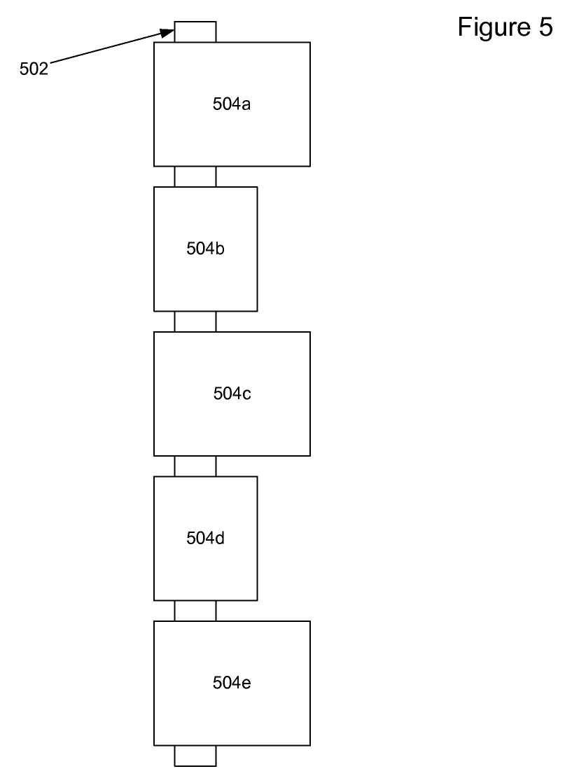

Referring now to FIG. 5, structure 502 is shown with a plurality of fairings 504a-504e mounted about the structure. Long fairings 504a, 504c, and 504e, are alternated with short fairings 504b and 504d. Short fairings 504b and 504d may be a lower cost to long fairings 504a, 504c, and 504e, and/or may act to reduce correlation of vortices between adjacent long fairings. In some embodiments, collars may be installed between adjacent fairings or placed between every few fairings.

In some embodiments, several short fairings may be placed between several long fairings, for example from about 4 to about 10 short fairings, then from about 4 to about 10 long fairings, then from about 4 to about 10 short fairings, and continuing in an alternating manner.

In some embodiments, fairing comprises a chord and a thickness as defined in U.S. Pat. No. 6,223,672. The chord may be measured from the front to the tail and defines a major axis, and thickness may be measured from one side to the other. In some embodiments, the chord to thickness ratio may be at least about 1.10. In some embodiments, the chord to thickness ratio may be at least about 1.25. In some embodiments, the chord to thickness ratio may be at least about 1.50. In some embodiments, the chord to thickness ratio may be at least about 1.75. In some embodiments, the chord to thickness ratio may be up to about 10.0. In some embodiments, the chord to thickness ratio may be up to about 5.0. In some embodiments, the chord to thickness ratio may be up to about 3.0. In some embodiments, the chord to thickness ratio may be up to about 2.0. In some embodiments, the fairing may have a cross-sectional shape selected from a teardrop, an airfoil, an ellipse, an oval, and/or a streamlined shape.

In some embodiments, the fairing may be mounted upon a structure for underwater deployment, the fairing comprising a fairing body which, viewed along its length, may be substantially wedge-shaped or tear-drop shaped, having a relatively broad front tapering to a relatively narrow trailing edge, and optionally at least two collars which may be both secured to the fairing body and may be separated from each other along the length of the fairing body, the collars being positioned and aligned to receive the structure, thereby to pivotally mount the fairing body upon the structure such that it may be able to rotate about the axis of the structure and so align itself with a water current, the fairing body defining, when viewed along the length of the fairing, a teardrop shape. The collar may be shaped to form a respective bearing ring for receiving the structure. Each bearing ring may have a substantially circular interior surface. A bearing surface of the collar, which faces toward the structure and upon which the collar rides, may comprise low friction material. The bearing surface may be self lubricating. The collar may comprise a plastics material with an admixture of a friction reducing agent.

In some embodiments, the fairing may be seen to be generally wedge shaped. Its front, lying adjacent the structure, may have a lateral dimension similar to that of the structure. Moving toward its rear the fairing tapers to a narrow trailing edge. This tapered shape may be defined by convergent walls, which meet at the trailing edge. The front of the fairing may be shaped to conform to the adjacent surface of the structure, being part cylindrical and convex. The fairing may form a streamlined teardrop shape. In a manner which will be familiar to the skilled person, this shape tends to maintain laminar flow and serves both to reduce drag and/or to prevent or reduce VIV.

In some embodiments, the fairing may be formed as a hollow plastics moulding whose interior communicates with the exterior to permit equalisation of pressure. In some embodiments, the fairing may be formed by a single plastics moulding, such as by rotational moulding, so that it may be hollow. The fairing may be manufactured of polythene, which may be advantageous due to its low specific gravity (similar to that of water), toughness and low cost. Openings may be provided to allow water to enter the fairing to equalize internal and external pressures. The fairing could also be formed as a solid polyurethane moulding. In some embodiments, the principal material used in constructing the fairing may be fiberglass. Other known materials may also be used which have suitable weight, strength and corrosion-resistant characteristics. In some embodiments, the fairings may be constructed from any metallic or non-metallic, low corrosive material such as a aluminum or multi-layer fiberglass mat, polyurethane, vinyl ester resin, high or low density polyurethane, PVC or other materials with substantially similar flexibility and durability properties. These materials provide the fairings with the strength to stay on the structure, but enough flex to allow it to be snapped in place during installation. The fiberglass may be 140-210 MPa tensile strength (for example determined with ISO 527-4) that may be formed as a bi-directional mat or the fairing can be formed of vinyl ester resin with 7-10% elongation or polyurethane. The use of such materials eliminates the possibility of corrosion, which can cause the fairing shell to seize up around the elongated structure it surrounds.

Collars may be provided to connect the fairing to the structure and/or to provide spacing between adjacent fairings along the structure. Collars may be formed by a single plastics moulding, such as nylon, or from a metal such as stainless steel, copper, or aluminum. In some embodiments, the internal face of the collar's bearing ring may serve as a rotary bearing allowing the fairing to rotate about the structure's longitudinal axis and so to weathervane to face a current. Only the collar may make contact with the structure, its portion interposed between the fairing and the structure serving to maintain clearance between these parts. This bearing surface may be (a) low friction and even “self lubricating” and/or (b) resistant to marine fouling. These properties can be promoted by incorporation of anti-fouling and/or friction reducing materials into the material of the collar. The material of the collar may contain a mixture of an anti-fouling composition which provides a controlled rate of release of copper ions, and/or also of silicon oil serving to reduce bearing friction.

In some embodiments, there may not be provided a collar, and the fairing may be mounted to the structure itself. That is, the fairing may be mounted directly upon the structure (or on a cylindrical protective sheath conventionally provided around the structure). A number of such fairings may be placed adjacent one another in a string along the structure. To prevent the fairings from moving along the length of the structure, clamps and/or collars may secured to the structure at intervals, for example between about every one to five fairings. The clamps and/or collars may be of a type having a pair of half cylindrical clamp shells secured to the structure by a tension band passed around the shells.

In some embodiments, the fairing may be designed so that it can freely rotate about the structure in order to provide more efficient handling of the wave and current action and VIV bearing on the structure. The fairings may not be connected, so they can rotate relative to each other. Bands of low-friction plastic rings, for example a molybdenum impregnated nylon, may be connected to the inside surface of the fairing that defines an opening to receive the structure. A low friction material may be provided on the portion of the fairing that surrounds a structure, for example strips of molydbodeum impregnated nylon, which may be lubricated by sea water.

In some embodiments, a first retaining ring, or thrust bearing surface, may be installed above and/or below each fairing or group of fairings. Buoyancy cans may also be installed above and/or below each fairing or group of fairings.

The methods and systems of the invention may further comprise modifying the buoyancy of the fairing. This may be carried out by attaching a weight or a buoyancy module to the fairing. In some embodiments, the fairing may include filler material that may be either neutrally or partially buoyant. The tail portion of each fairing may be partially filled with a known syntactic foam material for making the fairing partially buoyant in sea water. This foam material can be positively buoyant or neutrally buoyant for achieving the desired results.

In some embodiments, at least one copper element may be mounted at the structure and/or the fairing to discourage marine growth at the fairing—structure interface so that the fairing remains free to weathervane to orient most effectively with the current, for example a copper bar. In some embodiments, the fairings may be made of copper, or be made of copper and one or more other materials.

In some embodiments, the fairings may have a maximum ratio of length to width of from 2.0 or greater, or 1.5 to as low as about 1.25, 1.20, or 1.10.

The height of the fairing can vary considerably depending upon the specific application, the materials of construction, and the method employed to install the fairing. In extended marine structures, numerous fairings may be placed along the length of the marine structure, for example covering from about 15% or 25%, to about 50%, or 75%, or 100% of the length of the marine structure with the fairings.

In some embodiments, fairings may be placed on a marine structure after it is in place, for example, suspended between a platform and the ocean floor, in which divers or submersible vehicles may be used to fasten the multiple fairings around the structure. Alternatively, fairings may be fastened to the structure as lengths of the structure are assembled. This method of installation may be performed on a specially designed vessel, such as an S-Lay or J-Lay barge, that may have a declining ramp, positioned along a side of the vessel and descending below the ocean's surface, that may be equipped with rollers. As the lengths of the structure are fitted together, fairings may be attached to the connected sections before they are lowered into the ocean.

The fairings may comprise one or more members. Examples of two-membered fairings suitable herein include a clam-shell type structure wherein the fairing comprises two members that may be hinged to one another to form a hinged edge and two unhinged edges, as well as a fairing comprising two members that may be connected to one another after being positioned around the circumference of the marine structure. Optionally, friction-reducing devices may be attached to the interior surface of the fairing.

Clam-shell fairings may be positioned onto the marine structure by opening the clam shell structure, placing the structure around the structure, and closing the clam-shell structure around the circumference of the structure. The step of securing the fairing into position around the structure may comprise connecting the two members to one another. For example, the fairing may be secured around the structure by connecting the two unhinged edges of the clam shell structure to one another. Any connecting or fastening device known in the art may be used to connect the member to one another.

In some embodiments, clamshell type fairings may have a locking mechanism to secure the fairing about the structure, such as male-female connectors, rivets, screws, adhesives, welds, and/or connectors.

In some embodiments, fairings may be configured as tail fairings, for example as described and illustrated in co-pending U.S. application Ser. No. 10/839,781, which was published as U.S. Patent Application Publication 2006/0021560, and is herein incorporated by reference in its entirety.

In some embodiments, fairings may include one or more wake splitter plates. In some embodiments, fairings may include one or more stabilizer fins.

Of course, it should be understood that the above attachment apparatus and methods are merely illustrative, and any other suitable attachment apparatus may be utilized.

The methods and systems of the invention may further comprise positioning a second fairing, or a plurality of fairings around the circumference of a structure. In the multi-fairing embodiments, the fairings may be adjacent one another on the structure, or stacked on the structure. The fairings may comprise end flanges, rings or strips to allow the fairings to easily stack onto one another, or collars or clamps may be provided in between fairings or groups of fairings. In addition, the fairings may be added to the structure one at a time, or they may be stacked atop one another prior to being placed around/onto the structure. Further, the fairings of a stack of fairings may be connected to one another, or attached separately.

While the fairings have been described as being used in aquatic environments, they may also be used for VIV and/or drag reduction on elongated structures in atmospheric environments.

### Examples

A variety of different fairing configurations were attached to a 2.5 inch outside diameter pipe and subjected to an increasing flow speed from 1 to 7.5 feet per second in a current tank. The displacement of the pipe was measured as a function of time.

### Tests 1A & 1B:

For these tests an aluminum fairing with a chord to thickness ratio of 2.5, without stabilizers, was attached to the 2.5 inch outside diameter pipe and subjected to an increasing flow speed from 1 to 7.5 feet per second in the current tank. Test 1A was a solid tail, and Test 1B was a tail with perforations.

The fairing in Test 1A was unstable, meaning the instability continued to increase with increasing flow speeds, and never achieved equilibrium. In contrast, the fairing in Test 1B was stable and achieved equilibrium.

The fairing in Test 1B achieved a 24% decrease in Max RMS ND, and a 38% decrease in Max A/D when compared to the fairing in Test 1A.

The perforations in the tail of the fairing in Test 1B significantly increased the stability compared to the fairing without perforations.

### Tests 2A & 2B:

For these tests an aluminum fairing with a chord to thickness ratio of 2.59, with stabilizers, was attached to the 2.5 inch outside diameter pipe and subjected to an increasing flow speed from 1 to 7.5 feet per second in the current tank. Test 2A was a solid tail, and Test 2B was a tail with perforations.

The fairing in both Tests 2A and 2B were stable.

The fairing in Test 2B achieved a 73% decrease in Max RMS ND, and a 58% decrease in Max A/D when compared to the fairing in Test 2A.

The perforations in the tail of the fairing in Test 2B significantly increased the stability compared to the fairing without perforations.

### Tests 3A, 3B, & 3C:

For these tests an aluminum fairing with a chord to thickness ratio of 2.24, with stabilizers, was attached to the 2.5 inch outside diameter pipe and subjected to an increasing flow speed from 1 to 7.5 feet per second in the current tank. Test 3A was a solid tail, Test 3B was a tail with perforations, and Test 3C was a solid tail with added foam buoyancy.

The fairing in Test 3A was unstable, meaning the instability continued to increase with increasing flow speeds, and never achieved equilibrium. In contrast, the fairings in Tests 3B and 3C were stable and achieved equilibrium.

The fairing in Test 3B achieved a 52% decrease in Max RMS ND, and a 46% decrease in Max ND when compared to the fairing in Test 3A. The fairing in Test 3C achieved a 90% decrease in Max RMS A/D, and a 81% decrease in Max ND when compared to the fairing in Test 3A.

The perforations in the tail of the fairing in Test 3B significantly increased the stability compared to the fairing without perforations. The foam in the tail of the fairing in Test 3C significantly increased the stability compared to the fairing without foam in the tail.

The test data is presented below:

| | Max RMS | | Stable/ | Max RMS | Max A/D |
|---|---|---|---|---|---|
| Test | A/D | Max A/D | Unstable | A/D Change | Change |
| 1A | 0.17 | 0.63 | Unstable | | |
| 1B | 0.13 | 0.39 | Stable | 24% | 38% |
| 2A | 0.3 | 0.55 | Stable | | |
| 2B | 0.08 | 0.23 | Stable | 73% | 58% |
| 3A | 1.65 | 3.03 | Unstable | | |
| 3B | 0.79 | 1.65 | Stable | 52% | 46% |
| 3C | 0.17 | 0.57 | Stable | 90% | 81% |

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the invention, including all features which would be treated as equivalents thereof by those skilled in the art to which this invention pertains.

1. A system for reducing drag and/or vortex induced vibration of a structure, the system comprising:
a fairing comprising a dampening mechanism adapted to dampen the rotation of the fairing about the structure.

2. The system of claim 1, wherein the dampening mechanism comprises at least one mechanism selected from the group consisting of perforations in a tail section of the fairing, a mass in a nose section of the fairing, a buoyancy module in the tail section of the fairing, perforations and balls and/or rods in the tail section of the fairing, a liquid container in the tail section of the fairing, a liquid container in the nose section of the fairing, friction pads between the fairing and the structure, and pins attached to the fairing within tracks moveably connected to the structure.

3. The system of claim 1, wherein the fairing comprises a chord to thickness ratio of greater than 1.5.

4. The system of claim 1, wherein the fairing comprises a chord to thickness ratio of greater than 2.0.

5. The system of claim 1, wherein the fairing comprises a chord to thickness ratio of greater than 2.25 and less than 2.75.

6. The system of claim 1, wherein the fairing comprises a tail section comprising one or more stabilizer fins and/or drag plates.

7. The system of claim 1, wherein the fairing comprises a teardrop shape.

8. A method for modifying a structure subject to drag and/or vortex induced vibration, said method comprising:
positioning at least one fairing around the structure; and
dampening the rotation of the fairing about the structure.

9. The method of claim 8, wherein the positioning comprises positioning at least two fairings about the structure.

10. The method of claim 8, further comprising:
positioning a collar, a buoyancy module, and/or a clamp around the structure.

11. The method of claim 8, wherein the fairing comprises a teardrop shape.

12. The method of claim 9, further comprising connecting at least two fairings to each other.

13. The method of claim 8, further comprising positioning a plurality of long fairings about the structure and a plurality of short fairings about the structure, and alternating at least 1 short fairing between every group of long fairings, wherein the group of long fairings comprises from 1 to 8 fairings.

14. The method of claim 13, wherein the short fairing comprises a chord to thickness ratio of less than 1.5, and the long fairing comprises a chord to thickness ratio of greater than 1.75.

15. The method of claim 8, further comprising dampening a lateral motion of the fairing and/or the structure.

16. The method of claim 8, further comprising positioning a first group of fairings about the structure and a second group of fairings about the structure, and alternating at least 1 of the first group of fairings between every at least 1 of the second group of fairings, wherein the first group of comprises a different mass balance, a different dampening mechanism, and/or a different dampening level from the second group.
